(19) United States
(12) Patent Application Publication
(10) Pub. No.: US 2025/0144780 A1
(43) Pub. Date: May 8, 2025

(54) APPARATUS FOR REMOVING A SCREW FROM A RIM AND INTERCONNECTING THE SAME

(71) Applicant: U-CAR INDUSTRY CO., LTD., Taichung (TW)

(72) Inventor: JUNG-HUA CHUANG, TAICHUNG (TW)

(21) Appl. No.: 18/386,607

(22) Filed: Nov. 3, 2023

(51) Int. Cl. B25D 17/24

(52) U.S. Cl. CPC B25D 17/24; B25D 2250/371

(57) ABSTRACT

A screw-moving apparatus includes a nut and a buffer. The nut is engageable with a screw connected to a spacer to allow an impact tool to hit the nut to remove the screw from the spacer. The buffer is located between the nut and the spacer to reduce impact exerted on the spacer by the nut.

### BACKGROUND OF INVENTION

### 1. Field Of Invention

The present invention relates to a spacer between a rim of a wheel of a vehicle and an axle and, more particularly, to an apparatus for removing a screw from a rim and interconnecting the same.

### 2. Related Prior Art

A typical car includes two front wheels and two rear wheels. Each of the front and rear wheels is provided with a spacer. The spacers provide room for brakes.

Referring to FIG. 8, a spacer 80 is used with screws 82. The spacer 80 is substantially a disc formed with an internal side facing an axle of a car for example and an external side facing a rim of a wheel of the car. The spacer 80 includes apertures 81. Each of the screws 82 includes a flange located on an internal side of the spacer 80, a ridged section fitted in a corresponding one of the apertures 81, and a threaded section located on an external side of the spacer 80. The ridged section is made with a diameter larger than that of the flange or the threaded section.

In maintenance, a mechanic swings a hammer 87 to hit the threaded section of one of the screws 82 to remove the ridged section of the same from the corresponding aperture 81. Thus, the ridged section of a new screw 82 can be fitted in the corresponding aperture 81. However, it is not unusual that a user hits and damages the spacer 80 with the hammer 87.

The present invention is therefore intended to obviate or at least alleviate the problem encountered in the prior art.

### SUMMARY OF INVENTION

It is the primary objective of the present invention to provide a precise and efficient apparatus for removing a screw from a spacer and connecting the screw to the spacer.

To achieve the foregoing objective, the screw-moving apparatus includes a nut and a buffer. The nut is engageable with a screw connected to a spacer to allow an impact tool to hit the nut to remove the screw from the spacer. The buffer is located between the nut and the spacer to reduce impact exerted on the spacer by the nut.

Other objectives, advantages and features of the present invention will be apparent from the following description referring to the attached drawings.

### BRIEF DESCRIPTION OF DRAWINGS

The present invention will be described via detailed illustration of two embodiments referring to the drawings wherein:

FIG. 1 is a perspective view of a spacer, screws and a screw-moving apparatus in a disconnecting mode according to the first embodiment of the present invention;

FIG. 2 is an enlarged perspective view of a portion of the spacer, one of the screws and the screw-moving apparatus shown in FIG. 1;

FIG. 3 is a perspective view of the screw-moving apparatus in another position relative to the spacer and the screw than shown in FIG. 2;

FIG. 4 is a cut-away view of the screw-moving apparatus, the spacer and the screw shown in FIG. 3;

FIG. 5 is a partial and cross-section view of the screw-moving apparatus, the spacer and the screw shown in FIG. 3;

FIG. 6 is an exploded view of a screw-moving apparatus according to the second embodiment of the present invention;

FIG. 7 is a cut-away view of the screw-moving apparatus shown in FIG. 6; and

FIG. 8 is a perspective view of a spacer and screws.

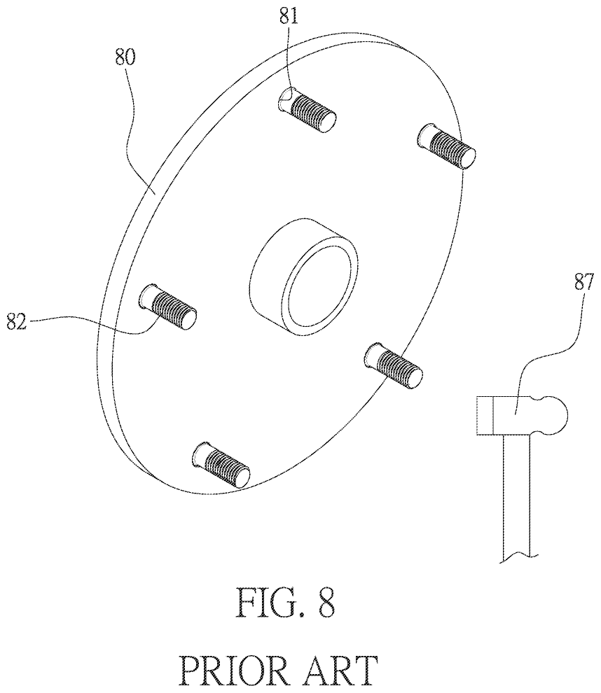

### DETAILED DESCRIPTION OF EMBODIMENTS

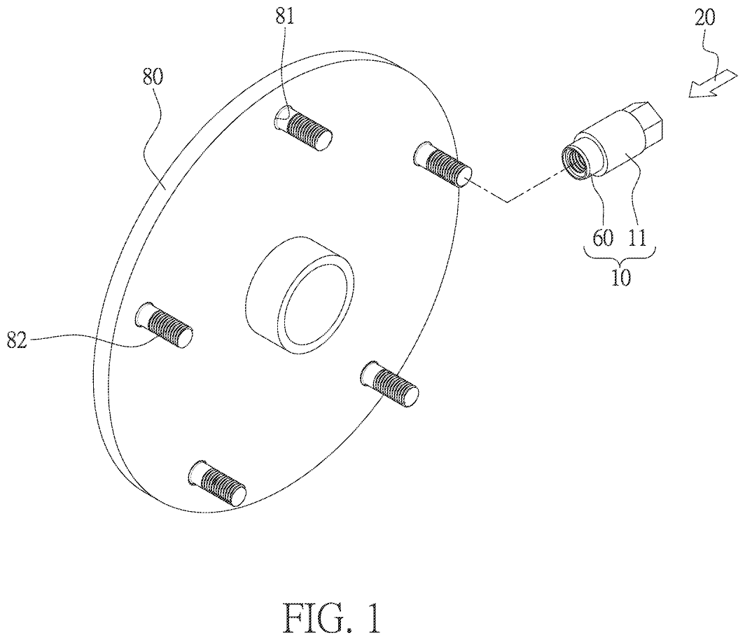

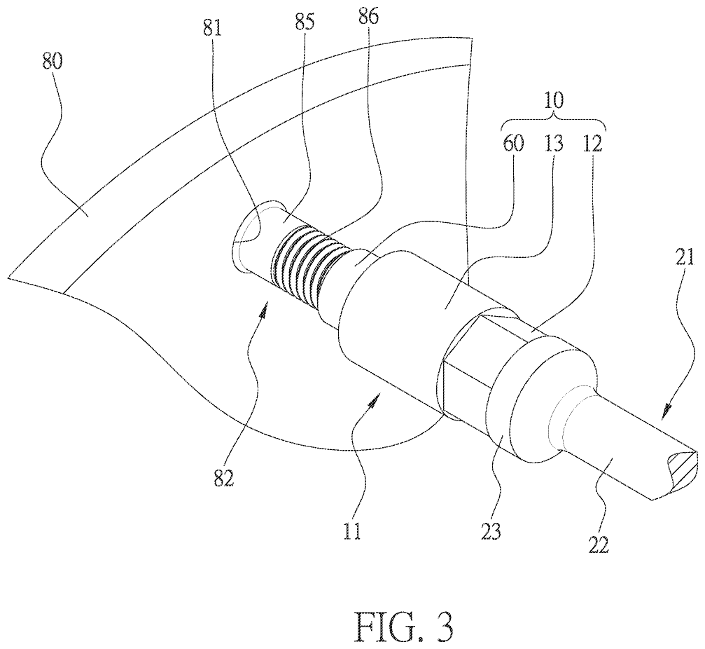

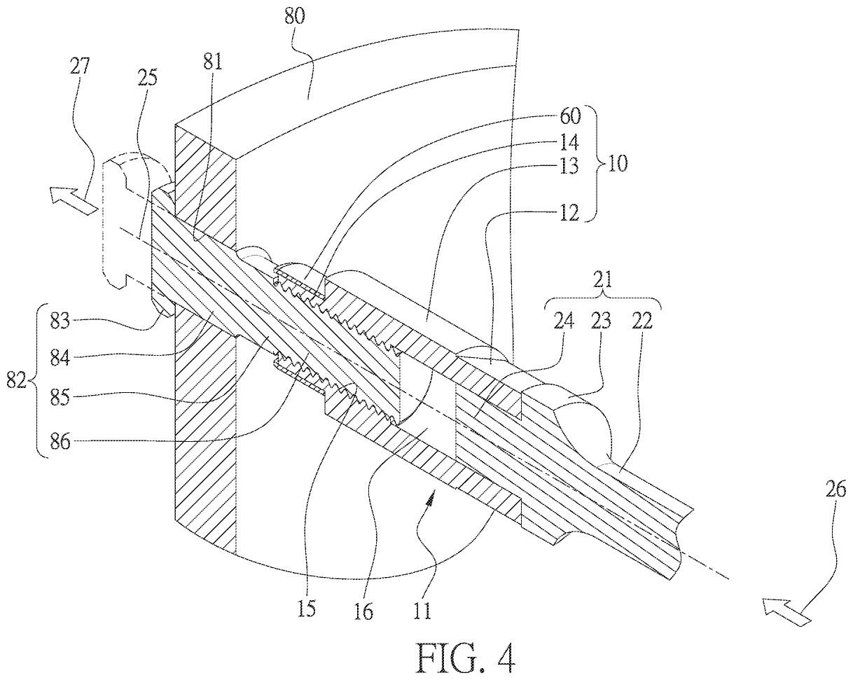

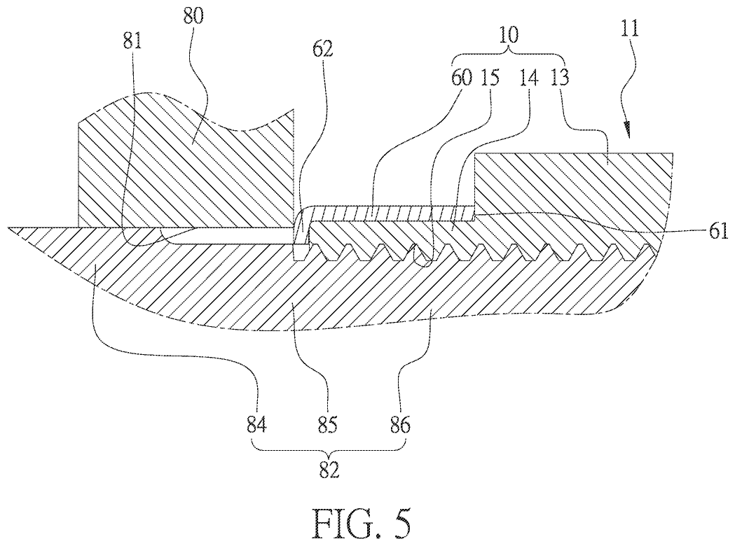

Referring to FIGS. 1 through 7, a spacer 80 is used with five screws 82. The spacer 80 includes five evenly-distributed apertures 81. Each of the screws 82 includes a flange 83 at an end, a ridged section 84 extending from the flange 83, a reduced section 85 extending from the ridged section 84, and a threaded section 86 extending from the reduced section 85.

In use, the flange 83 of each of the screws 82 is in contact with an internal side (not shown) of the spacer 80, the ridged section 84 is fitted in a corresponding one of the apertures 81, and the reduced section 85 and the threaded section 86 are located on an external side of the spacer 80. The ridged section 84 of each of the screws 82 prevents the screw 82 from rotation relative to the spacer 80.

Referring to FIG. 1, a screw-moving apparatus 10 includes a nut 11 and a buffer 60 according to a first embodiment of the present invention. The nut 11 is used alone as a screw-removing unit to remove the screws 82 from the spacer 80. The nut 11 is used to connect the screws 82 to the spacer 80 in a direction indicated by an arrow head 20.

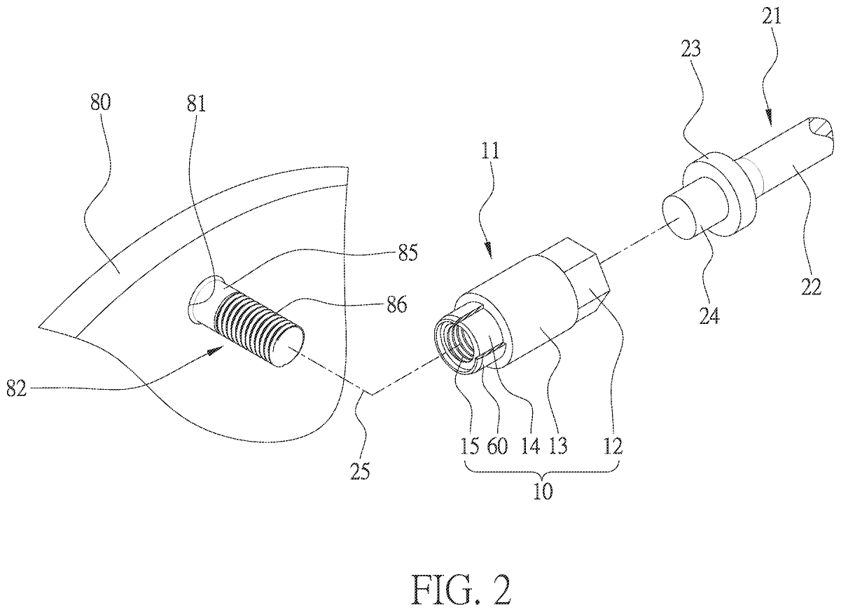

Referring to FIG. 2 through 5, the nut 11, the spacer 80 and only one of the screws 82 will be described. The nut 11 is used with a bit 21 of an automatic impact tool such as a pneumatic or electric impact tool (not shown) to remove the screw 82 from the spacer 80.

The nut 11 includes a polygonal section 12, an enlarged section 13, a reduced section 14, a screw hole 15 and a bore 16. The polygonal section 12 is formed at a first end of the nut 11. The polygonal section 12 is made with a diagonal considerably larger than a diameter of the screw 82 so that it is much easier to use the bit 21 or a hammer to hit the polygonal section 12 of the nut 11 than hit an end of the screw 82. Preferably, the polygonal section 12 is a hexagonal section. The bore 16 is made in the first end of the nut 11. The reduced section 14 is formed at a second end of the nut 11. The screw hole 15 is made in the second end of the nut 11. The enlarged section 13 is formed between the polygonal section 12 and the reduced section 14. In diameter, the enlarged section 13 is larger than the reduced section 14. The polygonal section 12, the enlarged section 13, the reduced section 14, the screw hole 15 and the bore 16 extend along an axis 25 of the nut 11. Preferably, the screw hole 15 is in communication with the bore 16. In another embodiment, the screw hole 15 is separated from the bore 16.

The buffer 60 is a tubular element made of an elastic material such as plastics, rubber and synthetic rubber. The buffer 60 is formed with a butt 61 at rear end and an internal flange 62 at a front end. In operation, the reduced section 14 of the nut 11 is inserted in the buffer 60. The buffer 60 is longer than the reduced section 14 of the nut 11 by the thickness of the internal flange 62. Hence, the butt 61 is in contact with a shoulder formed between the enlarged section 13 of the nut 11 and the reduced section 14 of the same while the internal flange 62 is in contact with a free end of the reduced section 14 of the nut 11.

Preferably, the buffer 60 is made with an internal diameter identical to or marginally smaller than a diameter of the reduced section 14 of the nut 11 to allow the buffer 60 to hold on to the reduced section 14 of the nut 11 in use.

The bit 21 includes a rod 22 at an end, an insert 24 at another end, and an enlarged section 23 between the rod 22 and the insert 24. Automatic impact tools can be seen in Taiwanese Patent Nos. M534076 and 1453098 and U.S. Pat. Nos. 6,962,211, 7523791 and 7886838.

The nut 11 is engaged with the screw 82, i.e., the screw hole 15 of the nut 11 receives the threaded section 86 of the screw 82. The insert 24 is inserted in the bore 16. The enlarged section 23 of the bit 21 is abutted against the polygonal section 12 of the nut 11. The automatic impact tool is turned on to drive the enlarged section 23 of the bit 21 to repeatedly hit the polygonal section 12 of the nut 11 in a direction indicated with an arrow head 26, thereby removing the ridged section 84 of the screw 82 from the corresponding aperture 81, i.e., removing the screw 82 from the spacer 80 in a direction as indicated with an arrow head 27. Then, the nut 11 is disengaged from the screw 82.

As described above, the nut 11 is an intermediate element between the screw 82 and the bit 21. The automatic impact tool is operable to drive the bit 21 to precisely and efficiently hit the screw 82 through the nut 11.

As described above, the internal flange 62 covers the free end of the reduced section 14 of the nut 11. Therefore, the free end of the reduced section 14 of the nut 11, which is made of metal, is kept from contact with the spacer 80. That is, the spacer 80 is protected from the nut 11 and the bit 21.

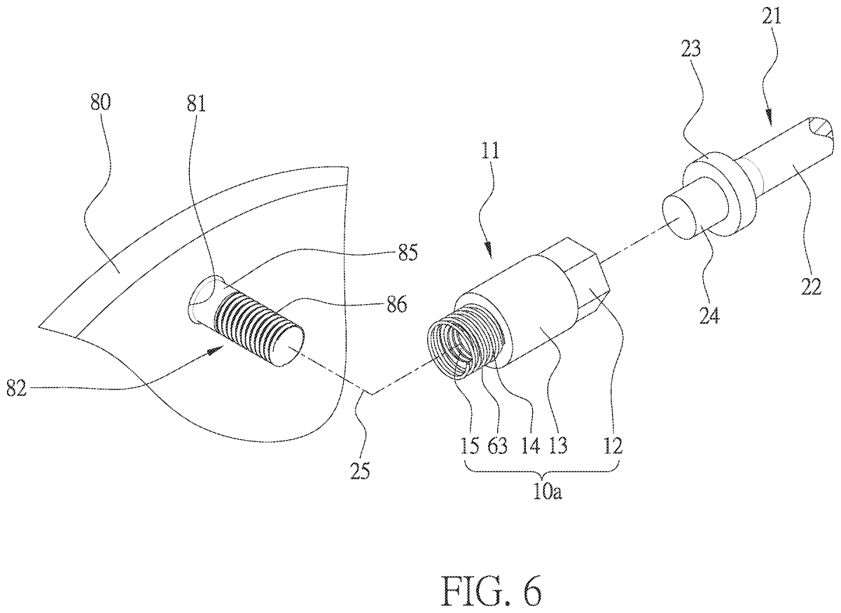

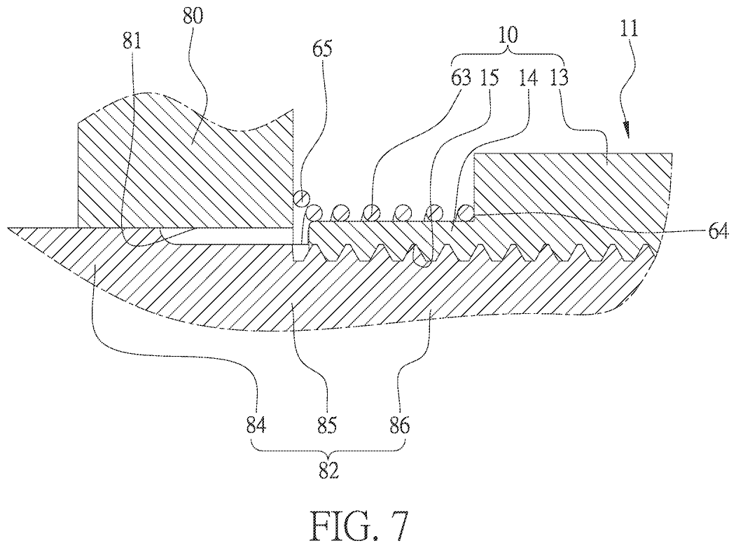

Referring to FIGS. 6 and 7, there is a screw-driving apparatus according to a second embodiment of the present invention. The second embodiment is identical to the first embodiment except for including a buffer 63 instead of the buffer 60. The buffer 63 is a helical spring made of metal or plastics for example. Preferably, the buffer 63 is a compression spring. The buffer 63 includes a rear end 64 and a front end 65. Preferably, the front end 65 of the buffer 63 expands. In operation, the reduced section 14 of the nut 11 is inserted in the buffer 63.

Normally, the buffer 63 is longer than the reduced section 14 of the nut 11. Hence, the rear end 64 of the buffer 63 is in contact with the shoulder formed between the enlarged section 13 of the nut 11 and the reduced section 14 of the same while the front end 65 of the buffer 63 is located beyond the free end of the reduced section 14 of the nut 11.

Preferably, the buffer 63 is made with an internal diameter identical to or marginally smaller than a diameter of the reduced section 14 of the nut 11 to allow the buffer 63 to hold on to the reduced section 14 of the nut 11 in use.

As described above, the buffer 63 extends longer than the reduced section 14 of the nut 11. Thus, the buffer 63 starts to be compressed before the spacer 80 is hit by the free end of the reduced section 14 of the nut 11. Hence, damage of the spacer 80 by the free end of the reduced section 14 of the nut 11 is minimized.

In another embodiment, the buffer is a helical spring shaped like a Slinky and made of metal or plastics for example.

To connect the screw 82 to the spacer 80, i.e., to insert the ridged section 84 of the screw 82 in the apertures 81 of the spacer 80, the threaded section 86 is extended through the aperture 81. The nut 11 is engaged with screw 82, i.e., the screw hole 15 of the former receives the threaded section 86 of the latter. The nut 11 is rotated relative to the screw 82, which is not allowed to spin relative to the spacer 80 due to adequate friction between the ridged section 84 of the screw 82 and a wall of the aperture 81. Thus, the ridged section 84 of the screw 82 is moved into the aperture 81. Finally, the ridged section 84 of the screw 82 is located in the aperture 81 of the spacer 80. The threaded section 86 of the screw 82 is inserted in the screw hole 15 of the nut 11. The flange 83 is in contact with the internal side of the spacer 80.

To rotate the nut 11 relative to the screw 82, a wrench (not shown) is engaged with the polygonal section 12 of the nut 11. The wrench is a socket wrench, a box-ended wrench, an open-ended wrench or a monkey wrench for example.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A screw-moving apparatus comprising:
a nut engageable with a screw connected to a spacer to allow an impact tool to hit the nut to remove the screw from the spacer; and
a buffer located between the nut and the spacer to reduce impact exerted on the spacer by the nut.

2. The screw-removing apparatus according to claim 1, wherein the buffer comprises a first end in contact with the nut and a second end in contact with the spacer before the nut reaches the spacer.

3. The screw-removing apparatus according to claim 2, wherein the buffer is a tube.

4. The screw-removing apparatus according to claim 3, wherein the buffer comprises a butt at the first end and an internal flange at the second end, wherein the internal flange is in contact with a free end of the nut.

5. The screw-removing apparatus according to claim 2, wherein the buffer is a helical spring.

6. The screw-removing apparatus according to claim 5, wherein the helical spring is a compression spring.

7. The screw-removing apparatus according to claim 1, wherein the nut comprises a reduced section inserted in the buffer so that a free end of the reduced section of the nut is located in the buffer.

8. The screw-removing apparatus according to claim 1, wherein the nut comprises a screw hole for receiving the screw and a bore for receiving an impact tool.

9. The screw-removing apparatus according to claim 2, wherein the nut comprises a polygonal section for engagement with a wrench.

10. The screw-removing apparatus according to claim 6, wherein the nut comprises an enlarged section formed between the reduced section and the polygonal section.
